(19) United States
(12) Patent Application Publication
(10) Pub. No.: US 2025/0068366 A1
(43) Pub. Date: Feb. 27, 2025

(54) INFORMATION PROCESSING DEVICE FOR DISPLAYING INTRODUCTION INFORMATION FOR MODEL OF PRINTER ACCORDING TO SUPPORT PROGRAM

(71) Applicant: BROTHER KOGYO KABUSHIKI KAISHA, Nagoya (JP)

(72) Inventor: Tatsuhiko SONE, Nagoya (JP)

(21) Appl. No.: 18/809,536

(22) Filed: Aug. 20, 2024

(30) Foreign Application Priority Data
Aug. 24, 2023 (JP) 2023-136152

(51) Int. Cl. G06F 3/12

(52) U.S. Cl. CPC G06F 3/1229; G06F 3/1204; G06F 3/1228

(57) ABSTRACT

The information processing device includes a user interface. A support program for supporting a generic printing program implemented with an operating system causes the information processing device to perform, in a case where the support program is started by the operating system after a print instruction is issued by an application program, transmitting a print command to a printer via the generic printing program. The support program causes the information processing device to further perform, in a case where the support program is started by the operating system based on a predetermined instruction, determining whether a predetermined condition is satisfied; and in a case where the determining determines that the predetermined condition is satisfied. The support program causes the information processing device to further perform, displaying introduction information for a model of the printer on the user interface. The introduction information is related to how to use the printer.

### REFERENCE TO RELATED APPLICATIONS

This application claims priority from Japanese Patent Application No. 2023-136152 filed on Aug. 24, 2023. The entire content of the priority application is incorporated herein by reference.

### BACKGROUND ART

In recent years, practical technologies have been developed for controlling printers without the use of a printer driver provided by a printer vendor. One such technology utilizes a generic printing program as a part of the operating system (OS) as standard. With this technology, the OS, upon detecting a printer, associates the printer with the OS-standard generic printing program. Thereafter, when a print instruction is received from that printer, the OS-standard generic printing program generates print data without the need for a printer driver provided a vendor of that printer, and thus can control printing based on the print data.

Because printer-specific settings cannot be made on the OS-standard generic printing program described above, there is a need for a support program specific to each printer vendor or each type of printer so as to support control based on the printer-specific settings of those printers. In such a technology, an extension program for supporting a specified printer is installed on a client computer possessing a universal printer driver.

### SUMMARY

However, even if an information processing device has such a support program installed thereon, it is conceivable that the user of the device may be unaware that the support program exists and may not be able to fully utilize a printer designed to be controlled by that support program. Therefore, it is desirable to guide or instruct a user who has purchased such a printer on suitable modes for using that printer. Additionally, the technology about the above-described extension program has also room for improvement because the extension program is equivalent to a support program, but there is no known-technology for guiding users on how to use a printer that is the subject of control by the extension program.

In view of the foregoing, it is an object of the present disclosure to provide a non-transitory computer readable storage medium storing a support program. The support program supports a generic printing program implemented with an operating system of an information processing device. The support program, when executed by a processor of the information processing device, causes the information processing device to perform: in a case where the support program is started by the operating system after a print instruction is issued by an application program, transmitting a print command to a printer via the generic printing program; in a case where the support program is started by the operating system based on a predetermined instruction, determining whether a predetermined condition is satisfied; and in a case where the determining determines that the predetermined condition is satisfied, displaying introduction information for a model of the printer on a user interface of the information processing device, the introduction information being information related to how to use the printer.

In order to attain the above and other objects, the present disclosure provides an information processing device. The information processing device includes a memory, a user interface, and a processor. When a support program is installed on the information processing device for supporting a generic printing program implemented with an operating system of the information processing device and the support program is executed by the processor, the support program causes the information processing device to perform: in a case where the support program is started by the operating system installed on the information processing device after a print instruction is issued by an application program, transmitting a print command to a printer via the generic printing program; in a case where the support program is started by the operating system based on a predetermined instruction, determining whether a predetermined condition is satisfied; and in a case where the determining determines that the predetermined condition is satisfied, displaying introduction information for a model of the printer on the user interface, the introduction information being related to how to use the printer.

In the above structures, the introduction information for the model of printer connected to the information processing device is displayed on the user interface. Accordingly, the user can learn how best to use the model of the printer.

### BRIEF DESCRIPTION OF DRAWINGS

FIG. 1 is a block diagram illustrating an electrical configuration of a personal computer.

FIG. 2 is a sequence diagram illustrating a procedure for installing a support program.

FIG. 3 is a sequence diagram illustrating a printing procedure.

FIG. 4 is a sequence diagram illustrating an introduction process.

FIG. 5 is an explanatory diagram illustrating an example of an introductory screen.

FIG. 6 is an explanatory diagram illustrating an example of an introductory screen.

FIG. 7 is an explanatory diagram illustrating an example of an introductory screen.

FIG. 8 is a sequence diagram illustrating a procedure for installing a support program.

### DESCRIPTION

Below, a personal computer (PC) using a support program according to embodiments will be described while referring to the accompanying drawings. This specification describes the support program executed on the PC. Note that the support program can be run on smartphones and mobile computers, as well as PCs.

### First Embodiment

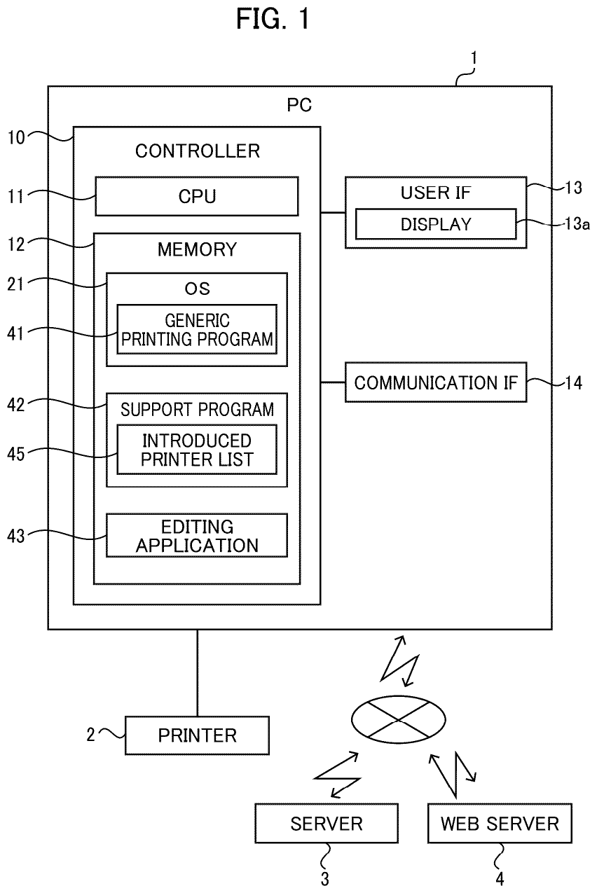

As shown in FIG. 1, the PC 1 of this embodiment is provided with a controller 10 that includes a CPU 11 and a memory 12. The PC 1 is an example of the information processing device of the present disclosure. The CPU 11 is an example of the computer and the processor of the present disclosure. The PC 1 is also provided with a user interface (also described as “user IF”) 13, and a communication interface (also described as “communication IF”) 14, both of which are electrically connected to the controller 10. Note that the controller 10 in FIG. 1 is a general concept that covers all hardware and software used for controlling the PC 1 and is not actually limited to representing a single piece of hardware present in the PC 1. The controller 10 may be an example of the computer and the processor.

The CPU 11 of the PC 1 executes various processes according to programs read from the memory 12 or based on user operations. The memory 12 stores various data and various application programs (hereinafter referred to as “apps”). The memory 12 is used as a work area for executing various processes. A buffer provided in the CPU 11 is also one example of a memory. Examples of the memory 12 may be a ROM, a RAM, a hard disk drive, or the like built into the PC 1 or may be any storage medium that is readable and writable by the CPU 11, such as a CD-ROM, a DVD-ROM, a USB memory, or other storage media.

The user interface 13 includes hardware that displays screens for reporting information to the user, and specifically a display 13a, and hardware that receives user operations. The user interface 13 may be a set of devices that includes the display 13a for displaying information, and a mouse, keyboard, and the like having input-receiving functions. Alternatively, the user interface 13 may be a touchscreen that is provided with both the function of the display 13a and an input-receiving function.

The communication interface 14 includes hardware that communicates with external devices such as a printer 1. That is, the communication interface 14 may be a network interface. The communication interface 14 employs, as a communication standard, Ethernet, Wi-Fi (U.S. trademark of Wi-Fi Alliance CORPORATION), or USB, for example. The PC 1 may be capable of connecting to the Internet 100 via the communication interface 14. Alternatively, the PC 1 may be provided with a plurality of communication interfaces 14 supporting a plurality of communication standards.

As shown in FIG. 1, the memory 12 of the PC 1 stores various programs and various data including an operating system (hereinafter “OS”) 21, a support program 42, an editing application 43, and an introduced printer list 45. The OS 21 includes a generic printing program (universal printing program) 41. The support program 41 is an example of the support program, and the editing application 43 is an example of the application program.

The OS 21 is a multitask OS that handles task management to execute concurrently the plurality of tasks while switching the tasks. The OS 21 is one of Windows (U.S. trademark of Microsoft Corporation), macOS (U.S. trademark of Apple Inc.), Linux (U.S. trademark of Torvalds, Linus), iOS (U.S. trademark of Cisco Technology, Inc.), and Android (U.S. trademark of Google LLC Limited), for example.

The generic printing program 41 is implemented with the OS 21. The generic printing program 41 may be installed on the PC 1 separately from the OS 21. Alternatively, the generic printing program 41 may be implemented in (or embedded in) the OS 21. The generic printing program 41 is an OS-standard program prepared by the vendor of the OS 21 and provided as part of the OS 21. In other words, the OS 21 having the generic printing program 41 is installed on the PC 1. The generic printing program 41 is not configured to use printer drivers specific to individual printers. The generic printing program 41 may be completely or partially encompassed by the OS 21.

The generic printing program 41 functions to execute printing, which is based on user instruction, on a plurality of models of printers provided by a plurality of vendors. The generic printing program 41 supports generic functions that allow printing to be performed on many printers. Unlike printer drivers designed for specific types of printers, the generic printing program 41 does not support functions that are specific to each printer or printer driver, particularly those functions that require complex processing.

The generic printing program 41 includes functions for receiving image data specified as the printing target in print instructions outputted from various apps based on user instructions and for generating intermediate data based on that image data. An example of intermediate data is XML Paper Specification (XPS) data. Here, XML is an abbreviation of Extensible Markup Language. The generic printing program 41 also has a function for generating print data based on intermediate data in a format that can be used for printing on various printers. An example of print data is PWG Raster data or PDF data. The generic printing program 41 also has a function for transmitting the generated print data to a printer designated as the device for executing the print via a communication function of the OS 21.

The support program 42 is a program or a set of programs that execute processes based on instructions from the OS 21 in conjunction with the processes of the generic printing program 41 and is a program that provides control support for the target hardware. The support program 42 of the present embodiment supports the model of printer 2 connected to the PC 1 and is provided by the vendor of the printer 2, for example. That is, the support program 42 is designed for the model of printer 2. The generic printing program 41 starts the support program 42 associated with the printer 2 in the following cases including: a case that the printer 2 is selected as the device to execute a print, a case that an instruction for advanced print settings is received while the printer 2 is selected, and a case that an instruction to execute a print on the printer 2 is received. To start the support program 42, the generic printing program 41 or the OS 21 may issue a starting instruction to starts the support program 42. The support program 42 is called as a Print Support Application (PSA) or a Hardware Support Application (HSA), for example. The instructions to start the support program 42 are examples of the predetermined starting instruction.

The support program 42 can be started from the generic printing program 41 or the OS 21 or can be manually started through a user operation. The support program 42 can be manually started through several user operations. For example, when the user opens a printer selection screen from the settings screen of the OS 21 and selects the printer 2 in the printer selection screen, a settings screen for the printer 2 is displayed on the display 13a. This settings screen includes a Start button. More specifically, in a state that the support program 42 is installed on the PC 1, an open printer app (OPA) for starting up the support program 42 in association with the generic printing program 41 is operably displayed in the settings screen for the printer 2. The support program 42 can be manually started only by operating this OPA. By operating the Start button (e.g., the OPA), the user can manually start up the support program 42.

The support program 42 has a function for performing an introduction process when started up from the OS 21 or generic printing program 41 based on a predetermined startup instruction. In the introduction process, the support program 42 displays introduction information corresponding to the model of the printer 2 connected to the PC 1 on the user interface 13, provided that one of the predetermined conditions for displaying introduction information is satisfied. The introduction information describes ways of using the printer. In the present embodiment, the introduction information is different for each model of printer, but the information may be common for a plurality of models. The introduction process and introduction information will be described later.

The introduced printer list 45 is stored in a storage area (e.g., a registry) of the memory 12 managed by the OS 21 for the support program 42. The introduced printer list 45 stores device identification information on each printer for which introduction information was displayed in association with an introduction date and time at which the introduction information was displayed. The device identification information is unique identification information for the printer. For example, device identification information may be a serial number, IP address, or MAC address.

The support program 42 may be a combination of a plurality of programs, each of which receives execution commands, or may be a single program that can execute different processes according to the received commands. The vendors of printers may prepare a support program for each type of printer. For example, one support program may be prepared for inkjet printers and another support program may be prepared for laser printers. Alternatively, a support program may be prepared for each model series rather than each type of printer.

When a new printer is connected to the PC 1, for example, the OS 21 of the PC 1 can download the appropriate support program from a server of the vendor of the printer or the like based on the type or model of the connected printer and can install this program on the PC 1. The OS 21 stores identification information for the installed support program in the memory 12 in association with printer information on the newly connected printer.

The editing application 43 is a program used for creating and editing image data and document data, for example. Examples of the editing application 43 include Word and PowerPoint (U.S. trademark of Microsoft Corporation) developed by Microsoft (U.S. trademark of Microsoft Corporation), and a program provided by the vendor of the printer 2. The editing application 43 accepts instructions via the user interface 13, such as a print execution instruction for instructing the printer 2 to execute a print. The editing application 43 is not limited to a program for creating and editing data but may be a program that accepts print execution instructions and display instructions for displaying various types of information, such as map information and web pages, in response to user requests.

As shown in FIG. 1, the PC 1 of the present embodiment is connected to the printer 2 via the communication interface 14. The printer 2 is a device having at least a printing function and a communication function. When print data is received from the PC 1 or the like, for example, the printer 2 can execute a print operation based on this print data. The printer 2 may be capable of performing color printing or may only be capable of monochrome printing. The printer 2 may be an inkjet printer or a laser printer. The printer 2 is equipped with consumables and optional accessories supported by the model of the printer 2. Examples of consumables are ink cartridges and toner cartridges. Examples of optional accessories are finishers and expansion trays.

The PC 1 according to the embodiment is connected to a server 3 and a web server 4 via the communication interface 14. The server 3 functions to transmit or distributes various application programs, such as the support program 42, to the PC 1 or other external devices. The web server 4 functions to provide web pages that differ according to the model of printer to the PC 1 or other external devices.

The following is a description of steps in various processes for installing the support program 42 on the PC 1 of the present embodiment and for using the support program 42 thereafter for controlling the printer 2 to print. The processes in the present embodiment essentially indicate processes performed by the CPU 11 according to commands described in the support program 42 and other programs. Processes performed by the CPU 11 include hardware control using the API in the OS 21. A detailed description of the role of the OS 21 is omitted in this specification when describing operations according to the programs. Further, the term “acquire” is used as a concept that does not necessarily require a request.

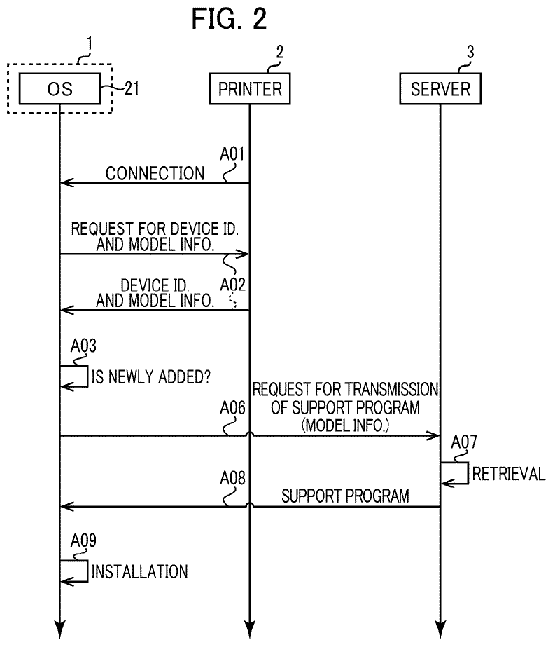

Here, an installation procedure will be described with reference to the sequence chart of FIG. 2. In A01 of this example, the OS 21 of the PC 1 detects that the printer 2 is connected to the PC 1. In response to detection of the printer 2, in A02 the OS 21 sends a request for device identification information and model information of the printer 2 to the printer 2, and acquires the device identification information and model information of the printer 2. In A03 the OS 21 determines based on the acquired device identification information whether the printer 2 is a new device to be added. When the printer 2 is a new device, in A06 the OS 21 sends a request to the server 3 through the communication interface 14 requesting the server 3 to transmit a support program. This request includes the model information obtained in A02.

In A07 the server 3 retrieves the support program 42 associated with the model information included in the request, and in A08 transmits this support program 42 to the PC 1. Upon receiving the support program 42 through the communication interface 14, in A09 the OS 21 stores the support program 42 in the memory 12 in association with the printer 2 so that installation of the support program 42 on the PC 1 is complete.

Thus, the OS 21 automatically downloads the support program 42 from the server 3 and installs the support program 42 on the PC 1 when the printer 2 is added to the PC 1, without requiring any installation operations by the user.

The support program 42 may also be installed on the PC 1 when the printer 2 is added in accordance with settings on the PC 1 side. For example, the user first connects the printer 2 to the PC 1 and then performs operations on the user interface 13 of the PC 1 to initiate a printer search. The user then selects the printer 2 from among the printers detected in this search, at which time the OS 21 downloads the support program 42 from the server 3 and installs the support program 42 on the PC 1.

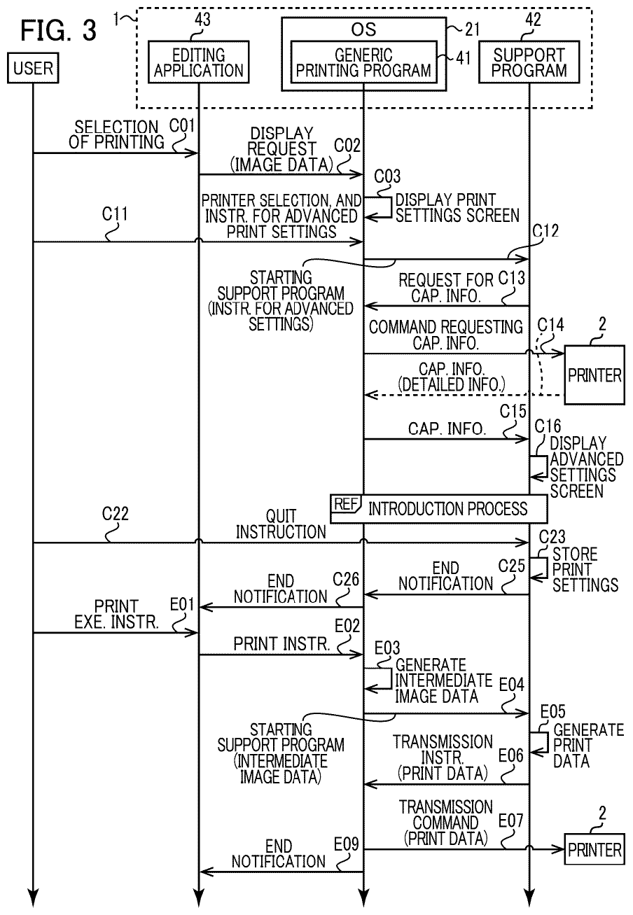

Next, a printing procedure will be described with reference to the sequence chart in FIG. 3. The editing application 43 accepts user instructions to create and edit text and images. When the user wishes to print the displayed text and images, in COI the user selects “Print” in the editing application 43. For example, the user can select a print option from a menu of operations provided in the editing application 43.

Upon receiving a selection to print, in C02 the editing application 43 issues a request to the generic printing program 41 of the OS 21 to display a screen that accepts printing-related instructions. The request may include image data to be printed. In response to this request, in C03 the generic printing program 41 displays a print settings screen on the user interface 13. The print settings screen accepts user instructions for various print settings supported by the generic printing program 41. As an alternative, the editing application 43 may display the print settings screen.

The print settings screen includes a printer selection field, a basic print settings selection area, an Advanced Settings button, and a Print button, for example. The printer selection field is provided for selecting a printer to execute the print. The basic print settings selection area accepts basic settings, such as the number of print copies, and the orientation of the document. The Advanced Settings button accepts an instruction to perform advanced settings not included in the basic print settings selection area. The Print button accepts an instruction to execute a print using the selected print settings. The print settings screen may also have a preview display area for displaying a preview of the image to be printed.

This example will assume that the user operates the Advanced Settings button after selecting the printer 2 in the printer selection field to be the device executing the print. In C11 the generic printing program 41 receives an instruction to perform advanced print settings in response to this operation of the Advanced Settings button, and in C12 passes an instruction to the support program 42 associated with the printer 2 instructing the support program 42 to begin accepting advanced print settings. For sending the instruction to begin accepting advanced print settings, the generic printing program 41 or OS 21 may start up the support program 42, and thereafter the generic printing program transmits the instruction to the support program 42 to begin accepting advanced print settings. The instruction transmitted in C11 is an example of a print instruction and a predetermined starting instruction.

When started up in response to the instruction received in C12, the support program 42 obtains capability information on the printer 2 according to the following procedures. Specifically, in C13 the support program 42 issues a request to the generic printing program 41 to acquire the capability information. In C14 the generic printing program 41 transmits a command to the printer 2 requesting capability information and subsequently acquires the capability information from the printer 2. In C15 the generic printing program 41 passes the capability information acquired in C14 to the support program 42, whereby the support program 42 can obtain capability information on the printer 2.

The capability information includes detailed information for selecting the introduction information to be displayed. Examples of detailed information include device identification information, model information, region information, and component information. The model information is a model name, for example. The region information specifies the region in which the printer 2 connected to the PC 1 is being used. The region information may indicate a target region for usage of the printer 2. When the region can be identified by analyzing the model information, region information need not be included in the detailed information. The component information relates to components mounted in the printer 2. Examples of the component information include consumable information on consumables mounted in the printer 2, and option information on optional accessories mounted in the printer 2. The series of processes of C13-C15 is an example of the step, process or instruction of acquiring identification, the region information acquisition process, the component information acquisition process.

In C14 the generic printing program 41 communicates with the printer 2 via the OS 21 according to the Internet Printing Protocol (IPP), for example. Note that rather than sending a request to the generic printing program 41, the support program 42 may acquire the capability information directly from the printer 2 using a management information base (MIB), for example.

In C16 the support program 42 displays an advanced settings screen reflecting the capability information on the display 13a. The advanced settings screen includes items and parameters for print settings specific to the printer 2, as well as items and parameters for generic print settings. Some examples of specific print setting items are items for watermark printing and barcode printing. Examples of specific parameters are a parameter specifying a postcard size, and parameters for an extension tray, such as a parameter indicating whether the extension tray is mounted on the printer 2 and a parameter specifying the expansion tray (a model of the extension tray). The advanced settings screen also includes an OK button that receives an instruction to end the advanced print settings. The process of C16 is an example of the screen display process. The advanced setting screen is an example of the screen that the set of support program instructions can provide.

The support program 42 also performs an introduction process that will be described later. Following the introduction process, the user operates the OK button in the advanced settings screen to accept the advanced print settings and quit the settings screen. In C22 the support program 42 receives an instruction to quit the advanced print settings screen in response to this operation of the OK button, and in C23 stores the print settings received through the advanced settings screen in the memory 12. In C25 the support program 42 closes the advanced settings screen and sends an end notification to the generic printing program 41. In C26 the generic printing program 41 passes an end notification to the editing application 43, whereby the editing application 43 can recognize that the setup process for advanced print settings was completed. After sending the end notification, the support program 42 may terminate.

After the user has finalized the image to be printed and the print settings for the printer 2, in E01 the user inputs an instruction in the editing application 43 to execute the print. For example, when an operation on the Print button is received through the print settings screen displayed in C03, the editing application 43 determines that an execution instruction was received, instructing the generic printing program 41 to direct the printer 2 to print the selected image. Alternatively, the generic printing program 41 may directly receive the instruction to execute the print inputted by the user and pass the instruction to the editing application 43.

In E02 the editing application 43 passes a print instruction to the generic printing program 41. The print instruction includes information concerning the received print execution instruction, such as image data representing an image to be printed and settings-specifying information specifying print settings. Here, the print settings in the settings-specifying information may be different from the print settings stored in C23. The settings-specifying information may include. The generic printing program 41 obtains the image data representing the image to be printed and the settings-specifying information specifying the print settings from the editing application 43 as information included in the print instruction.

In E03 the generic printing program 41 generates intermediate image data by converting the format of the image data representing the image to be printed to the format of intermediate image data based on the information acquired from the editing application 43. Because the editing application 43 generates image data of various types, the generic printing program 41 converts the image data to be printed to intermediate image data that is suitable for generating print data. When the image data to be printed is already suitable for generating print data, the generic printing program 41 may skip the process to generate intermediate image data and may use the image data received from the editing application 43 as the intermediate image data.

Prior to generating the intermediate image data, the generic printing program 41 may also start up the support program 42 corresponding to the printer 2, which is the designated printing device, and notify the support program 42 that processing of a print job has begun. When started up from the generic printing program 41, the support program 42 can pass information specifying various instructions for use in generating intermediate image data to the generic printing program 41 as needed.

After generating the intermediate image data, in E04 the generic printing program 41 starts up the support program 42. The support program 42 can acquire the intermediate image data generated by the generic printing program 41 by sending a request to the generic printing program 41. The support program 42 may acquire the settings-specifying information specifying the print settings as well as the intermediate image data as a response to the request. The support program 42 can then edit the intermediate image data and the print settings in the settings-specifying information received from the generic printing program 41 based on the print settings stored in the memory 12 in C23.

In E05 the support program 42 generates print data based on the intermediate image data and settings-specifying information received from the generic printing program 41 and the print settings stored in C23. In E06 the support program 42 passes the print data to the generic printing program 41 with an instruction to transmit the print data to the printer 2. The print settings stored in the memory 12 or received and edited in E04 may also be included with this instruction. In this way, the support program 42 can utilize the functions of the printer 2 by sending commands to the printer 2 that instruct the execution of specific processes available on the printer 2. After sending the print data, the support program 42 may terminate. The intermediate image data is an example of the image data. The process of E06 is a process for transmitting the transmission command (or the print command) to the printer 2 and an example of the step, process or instruction of transmitting.

The print data that the support program 42 passes to the generic printing program 41 in E06 should be in a format that can be printed on the printer 2. However, the PDL data generated by the support program 42 may be in a format that can be used for printing on printers other than the model of the printer 2. The PDL is abbreviation of Page Description Language.

In response to the instruction received from the support program 42, in E07 the generic printing program 41 transmits the print data together with a print command instructing the printer 2 to execute a print. The print command may include information on the print settings. The printer 2 executes a print based on the print data according to the print command. Following E07, in E09 the generic printing program 41 notifies the editing application 43 that the process has ended.

In the above description, the support program 42 passes the print data to the generic printing program 41 and the generic printing program 41 transmits the print data to the printer 2 with the print command. However, the support program 42 may instead transmit the print data to the printer 2 with the print command instructing the printer 2 to execute a print.

When the print settings include settings for an image process that can be executed on the printer 2, for example, the support program 42 may generate a print command that includes information for this process. In this case, the support program 42 may notify the generic printing program 41 that the process has ended after the transmission of print data is complete.

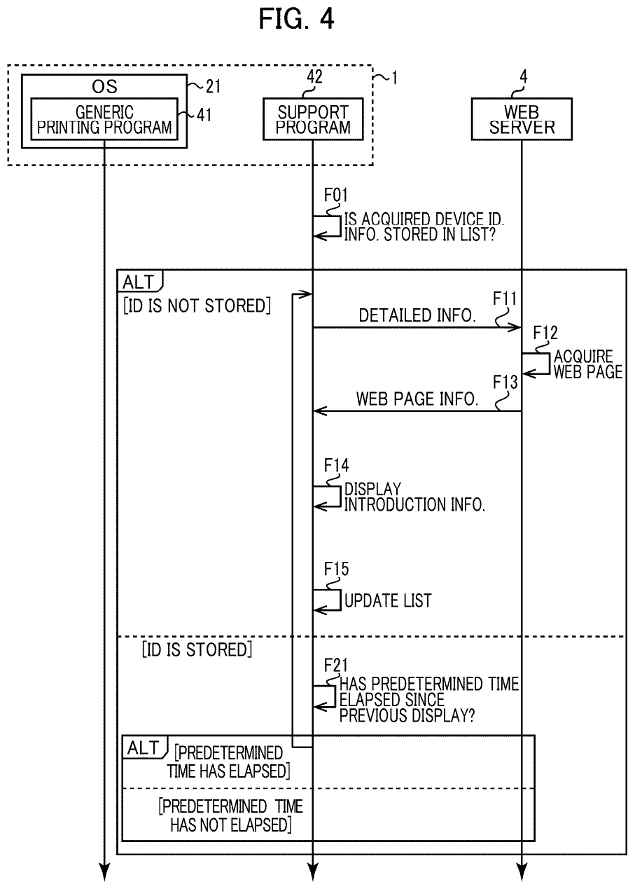

Next, a control procedure for the introduction process mentioned above in the printing procedure of FIG. 3 will be described with reference to FIG. 4. In F01 the support program 42 determines whether a determination condition is satisfied by determining whether or not the device identification information acquired from the printer 2 through the processes of C13-C15 of FIG. 3 is stored in the introduced printer list 45. That is, the determination condition is that the device identification information acquired from the printer 2 through the processes of C13-C15 of FIG. 3 is stored in the introduced printer list 45. The support program 42 may obtain the device identification information from the OS 21. The process of F01 is an example of the step, process, or instruction of determining. The determination condition of F01 is an example of the predetermined condition. As described above, the determination process of F01 is performed in a case where the support program 42 is started by the operating system 21 based on the print instruction as the predetermined starting instruction.

When the support program 42 is started for the first time after being installed on the PC 1, for example, the acquired device identification information is not stored in the introduced printer list 45. In this case (alt: not stored), assuming the support program 42 itself possesses a browser function, in F11 the support program 42 transmits the detailed information acquired from the printer 2 in C13-C15 of FIG. 3 to the web server 4.

In F12 the web server 4 identifies the model of the printer based on the model information included in this detailed information and acquires a web page corresponding to the identified model. For example, the web server 4 can access a management database managing web pages for each model of printer. The web server 4 then acquires the web page associated with the identified model and region information included in the detailed information by reading this web page from the management database. The management database may be stored on the web server 4 or an external device.

The web page includes device identification information, introduction information, a customer appreciation message, support program information, and component introduction information, for example. The device identification information is the same information contained in the detailed information.

The introduction information is information on how to use the printer. Some examples of introduction information include information on the printer's capabilities, functions and/or features, and information on services that use the printer. The introduction information may also include information on software that uses the printer. The customer appreciation message expresses thanks (or gratitude) to the user for purchasing the printer. The support program information introduces the capabilities, functions and/or features of the support program 42. The component introduction information introduces modes of using components mounted in the printer. The above information will be described later.

In F13 the web server 4 transmits web page information to the PC 1 for displaying the web page acquired in F12. When the support program 42 of the PC 1 receives the web page information through the communication interface 14, in F14 the support program 42 displays the web page on the display 13a. That is, the support program 42 displays an introductory screen on the display 13a that contains the introduction information and the like corresponding to the model of printer 2 connected to the PC 1. The introductory screen will be described later. The series of processes F11-F14 is an example of the step, process or instruction of displaying and the customer appreciation process.

The support program 42 displays the web page corresponding to the model of the printer where the web page includes introduction information and the like for this model. Therefore, the support program 42 is easy to maintain because the support program 42 itself need not prepare the introduction information, nor does the support program 42 need to be updated when the introduction information and the like are updated. Further, the support program 42 can perform the process to display the introduction information and the like without going through the generic printing program 41.

When the support program 42 does not possess a browser function, the support program 42 may transfer a URL for accessing the web server 4 to the browser of the OS 21 in order to display the web page in that browser, for example. In this case, the support program 42 may include the detailed information in the URL query passed to the browser. That is, the support program 42 may call a Web View embedded in the OS 21 and pass a URL for the web server 4 to the Web View in order to display the introduction information on the Web View. In a case where the support program 42 stores the URL of a web page for each model, the support program 42 may select the URL for the corresponding model of printer from among the stored URL and pass that URL to the browser. Alternatively, in a case where the support program 42 has a function to provide an introductory screen for each model, the support program 42 may display the introductory screen for the printer 2 on the display 13a without accessing the web server 4. In other words, the introduction information displayed by the support program 42 is not limited to information obtained from the web server 4 but may be information already stored in (or by) the support program 42.

After displaying the introductory screen in F14, in F15 the support program 42 stores the device identification information acquired through the processes of C11-C15 in the introduced printer list 45 in association with the introduction date and time (i.e., the date and time that the introductory screen was displayed). The process of F15 is an example of the step, process or instruction of storing.

The next time the support program 42 is started up from the OS 21, in F01 the support program 42 determines that device identification information is stored in the introduced printer list 45 (alt: stored). In this case, in F21 the support program 42 reads the date and time associated with the device identification information obtained in C11-C15 from the introduced printer list 45 and determines whether or not a predetermined time has elapsed since the previous display of introduction information.

When the predetermined time has not elapsed since the previous display of introduction information (alt: not elapsed), the support program 42 ends the introduction process without displaying the introduction information. That is, the support program 42 limits the frequency that the introductory screen is displayed so as not to cause the user irritation by repeatedly displaying an introductory screen with similar content.

On the other hand, when the support program 42 determines that the predetermined time has elapsed since the previous display of introduction information (alt: elapsed), the support program 42 repeats the processes of F11-F14 to redisplay the introductory screen associated with the model of printer. Because the support program 42 redisplays the introductory screen at this time, the user can review the introduction information and the like because the user may have completely forgotten or may just vaguely remember some content of the introduction information and the like after the predetermined time has elapsed since the user last viewed the introductory screen. Moreover, new components or new services for the printer may have been released since the user purchased the printer or since the introduction screen was previously displayed. In such cases, the web page on the web server 4 will have been updated. Accordingly, because the support program 42 redisplays the web page corresponding to the model of printer 2 connected to the PC 1, the user can discover the latest ways of using the printer and the latest components without updating the support program 42.

After redisplaying the introduction information, in F15 the support program 42 overwrites the introduction date and time associated with the device identification information acquired from the introduced printer list 45 with the date and time that the introduction information was redisplayed. By doing so, the support program 42 can prevent the introductory screen from being redisplayed until the predetermined time has elapsed since the current process.

As described above, the support program 42 of the present embodiment displays, on the user interface 13 of the PC 1, the introduction information and the like for the model of printer 2 connected to the PC 1, thereby enabling the user to learn modes of use suitable for this model of printer 2. Thus, the support program 42 according to this embodiment can guide the user in how best to use the printer 2, which is the subject of control by the support program 42, on the PC 1 having the embedded OS-standard generic printing program 41.

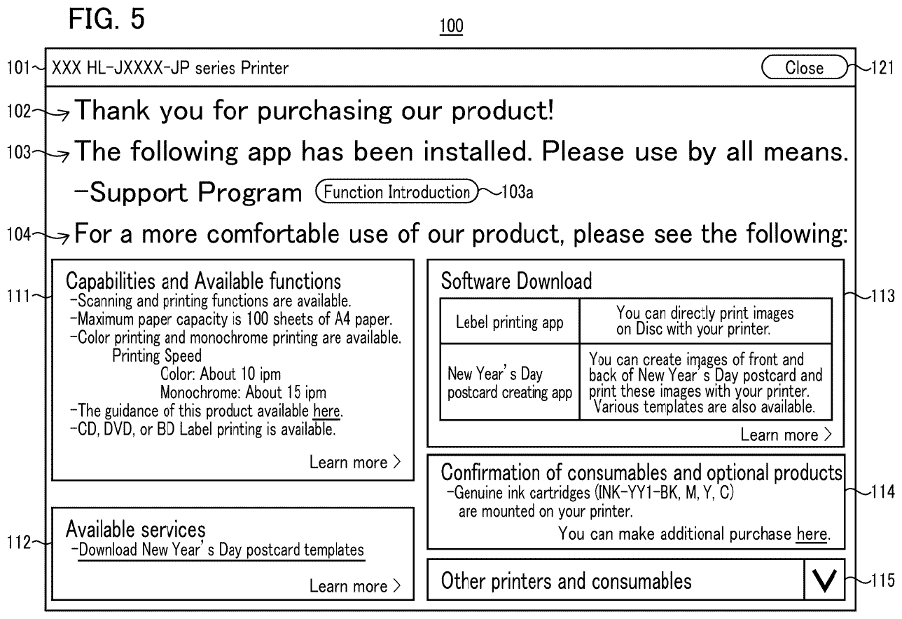

More specifically, since the support program 42 is automatically installed when the printer 2 is connected to the PC 1, users are unlikely to be aware of the existence of the support program 42 and may not be able to fully utilize capabilities, functions or features of the printer 2, services using the printer 2, and the like. For this reason, when started up for the first time after being installed on the PC 1, for example, the support program 42 of the present embodiment displays the introductory screen corresponding to the model of printer 2 connected to the PC 1 on the display 13a. The content displayed in this introductory screen differs according to the model of printer 2, the region in which the printer 2 is being used, and other factors. FIGS. 5 through 7 show examples of introductory screens.

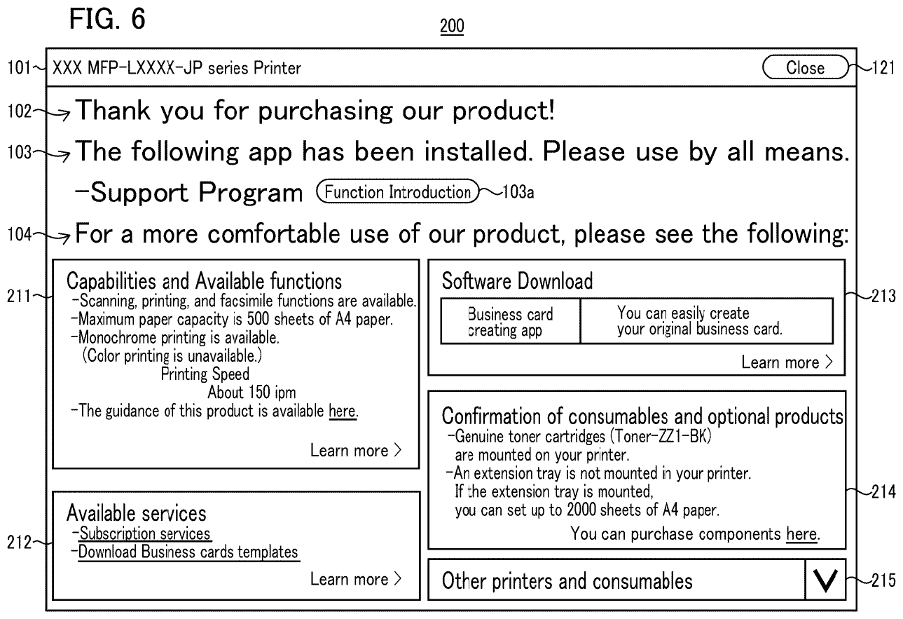

FIG. 5 shows an example of an introductory screen 100 displayed when the printer 2 is an inkjet printer intended for home use in Japan. FIG. 6 shows an example of an introductory screen 200 displayed when the printer 2 is a laser printer intended for office use in Japan. Though FIGS. 5 and 6 shows the content (messages and information) in the introductory screens 100 and 200 in English for the purpose of explanation, the actual content in the introductory screens 100 and 200 are both displayed in Japanese, which is the language associated with the region “Japan” in the region information where the printer 2 is being used. Alternatively, even when the printer 2 is for home use in Japan, the actual content in the introductory screens 100 and 200 may be displayed in English or other languages according to a user's language selection, for example.

The introductory screens 100 and 200 each includes a printer information display area 101, a customer appreciation display area 102, a support program introduction area 103, a guidance area 104, and a Close button 121, for example. The user can close the introductory screens 100 and 200 at any time by using the user interface 13 to operate the Close button 121.

The device identification information that the support program 42 obtained from the printer 2 through the processes of C11-C15 of FIG. 3, for example, is displayed in the printer information display area 101. This information enables the user to determine what printer is being introduced. The information displayed in the printer information display area 101 may be a model name or printer name for the printer 2 to be controlled by the support program 42. The customer appreciation message is displayed in the customer appreciation display area 102.

The support program introduction area 103 is provided for displaying support program information. The content of the support program information differs according to the type of support program. The support program introduction area 103 includes a message informing the user that the support program 42 has been installed, and a Function Introduction button 103a, for example. The Function Introduction button 103a is an operable object that accepts an instruction to display the functions of the support program 42. When the Function Introduction button 103a is operated, for example, details of the support program information are displayed, enabling the user to learn about the functions of the support program 42. The Function Introduction button 103a is associated with the URL of a web page displaying a description of the functions of the support program 42. When the Function Introduction button 103a is operated, the support program 42 may display this web page on the display 13a. Thus, the support program introduction area 103 makes the user aware of the existence of the support program 42 and facilitates the user in utilizing the capabilities, functions, and features of the printer 2.

The guidance area 104 is provided for displaying the introduction information and component introduction information. The guidance areas 104 in the introductory screens 100 and 200 include respective function guidance areas 111 and 211, service guidance areas 112 and 212, software guidance areas 113 and 213, component guidance areas 114 and 214, and other guidance areas 115 and 215. The content displayed in each area varies according to the model of printer.

The function guidance areas 111 and 211 display capabilities, functions, and features supported by the printer. For example, the function guidance area 111 in FIG. 5 displays home-oriented functions (capabilities, and features) such as color printing and label printing for CDs, DVDs, and BDs (Blu-ray Discs). The function guidance area 211 in FIG. 6 displays higher values than those in the function guidance area 111 of FIG. 5 for specifications such as the number of sheets that can be loaded in the printer, the printing speed, and the like. Each of the function guidance areas 111 and 211 in FIGS. 5 and 6 also display a link “learn more” to find more information on the corresponding printer. Accordingly, the user can learn functions specific to the printer 2 connected to the PC 1 to fully utilize the printer 2 more easily.

The service guidance areas 112 and 212 display services supported by the model of printer 2. For example, the service guidance area 112 in FIG. 5 displays information directing the user to a website for downloading New Year's Day postcard templates. The service guidance area 212 in FIG. 6, on the other hand, displays information directing the user to a website offering one or more subscription services that would enable the user to print up to a certain number of sheets within a fixed period for a flat rate (flat fee), and to a website to download templates for business cards and the like. The subscription services include an automatic shipping service to automatically ship one or more consumables based on information on a residual amount of each consumable. The consumables may be ink cartridges or toner cartridges for different colors. Note, the service guidance area 212 shown in FIG. 6 may display direct information on the automatic shipping service, in place of the information concerning the subscription services. Here, the direct information on the automatic shipping service may include the name of the automatic shipping service and overviews of the automatic shipping service, and detailed information such as fees for the service.

The software guidance areas 113 and 213 display software supported by the model of printer 2. For example, the software guidance area 113 in FIG. 5 displays descriptions of a label printing application and a New Year's Day postcard creating application. The software guidance area 213 in FIG. 6, on the other hand, displays a description of a business card creating application, for example. The software guidance areas 113 and 213 may also include information instructing the user on how to download the displayed software, enabling the user to easily identify software that is beneficial for use with the printer 2.

The component guidance areas 114 and 214 display component introduction information based on the component information that the support program 42 acquired from the printer 2. For example, the component guidance area 114 in FIG. 5 displays the model numbers of the genuine ink cartridges mounted in the printer 2. The component guidance area 214 in FIG. 6 displays the model number of the toner cartridge mounted in the printer 2, for example. The component guidance area 214 also displays information indicating that an expansion tray is not installed in the printer 2, and information describing the capabilities, function, and features of the expansion tray. Each of the component guidance areas 114 and 214 also displays information on residual quantities of consumables and direct the user to a website for purchasing consumables, optional accessories, and other parts. When any new components have been released, information introducing these new products may be displayed in the component guidance areas 114 and 214. Accordingly, the user can easily purchase consumables suitable for the printer 2. These guidance areas can also make the user aware of the existence of optional accessories available for making the printer 2 more user-friendly.

The other guidance areas 115 and 215 display information that introduces different printer models from the printer 2. For example, the other guidance areas 115 and 215 may display information introducing higher-end models, so that the user can replace the current printer with a printer having more convenient capabilities, functions and/or features.

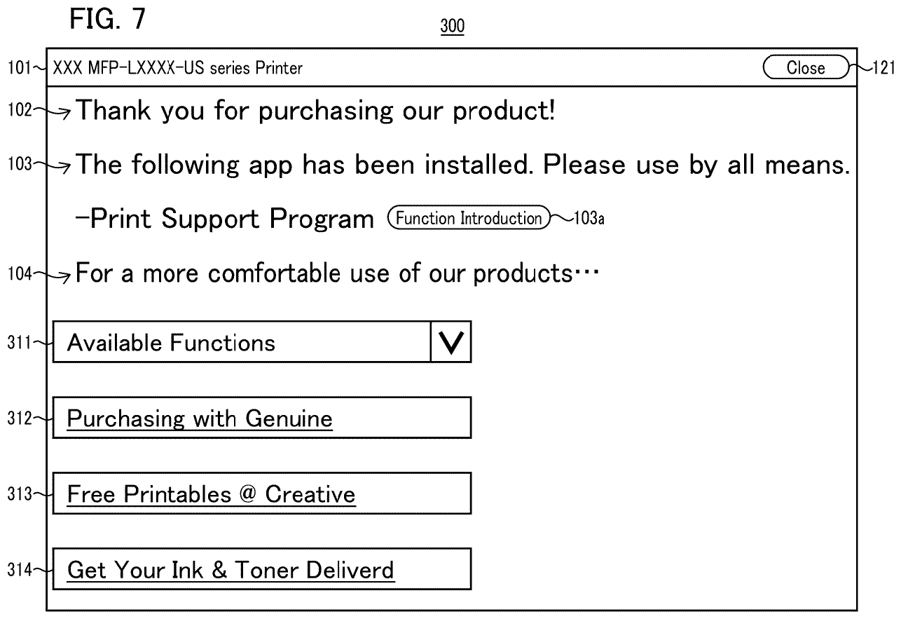

When the printer 2 is a laser printer model intended for business use in the United States, for example, an introductory screen 300 is displayed in English, as shown in FIG. 7. As with the introductory screens 100 and 200, the introductory screen 300 includes the printer information display area 101, customer appreciation display area 102, support program introduction area 103, guidance area 104, and Close button 121. In this example, the guidance area 104 is provided with an area 311 describing the functions (capabilities or features) and services available using the printer, and areas 312, 313, and 314 that provide guidance for using each service. The content of the guidance area 104 may vary by region, even among introductory screens of the same language in a case where the functions (capabilities, features) or services differ according to region, for example. Accordingly, the user can easily utilize the printer 2 by properly learning what functions are available in the language of the country where the printer 2 is being used.

### Second Embodiment

Next, the PC 1 according to a second embodiment will be described while referring to the accompanying drawings. In the second embodiment, the support program 42 automatically displays the introduction information when started up after installation. This differs from the first embodiment in which the support program 42 displays the introduction information when started up from the OS 21 in a case where such information has not yet been displayed. In the following description, configurations and process steps similar to those in the first embodiment are designated with the same reference numerals and step numbers, and descriptions of these configurations and steps are omitted as appropriate.

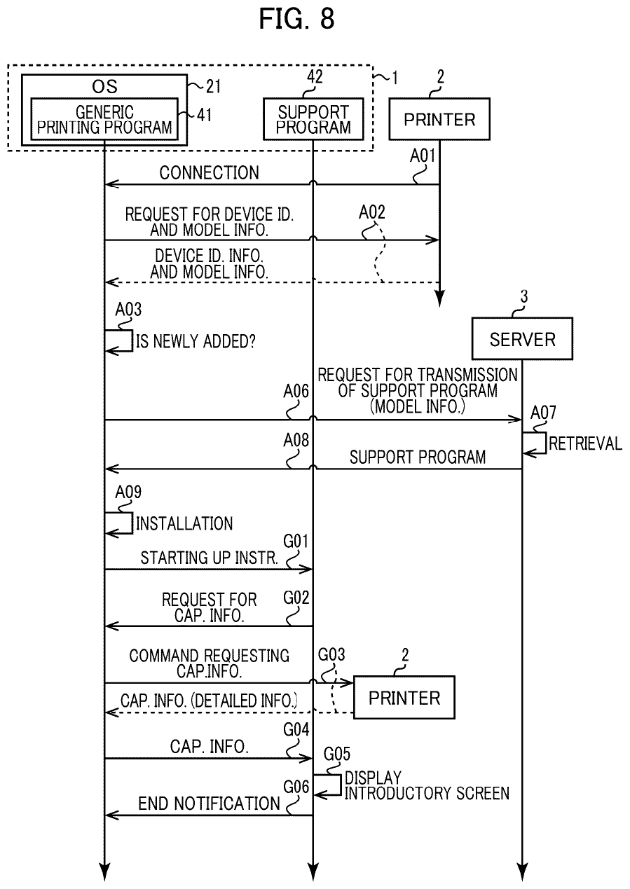

As shown in FIG. 8, the OS 21 of the PC 1 has downloaded the support program 42 corresponding to the printer 2 from the server 3 and installed the support program 42 on the PC 1 in A09. In response to installation of the support program 42 on the PC1, for example, in G01 the OS 21 starts up the support program 42. When starting up the support program 42, the OS 21 adds a startup option indicating that the support program 42 was just installed. That is, the OS 21 issues an instruction to start up the support program 42 with the startup option indicating that current starting up of the support program 42 is immediately after the installation of the support program 42. This instruction added with the startup option is an example of the predetermined starting instruction and the starting instruction immediately after the installation.

Note that an installer for installing the support program 42 on the PC 1 may start up the support program 42 with the added startup option after completing installation. This instruction outputted from the installer is an example of the predetermined starting instruction and the starting instruction immediately after the installation.

When started with this startup option, in G02-G04 the support program 42 acquires the capability information including detailed information from the printer 2 via the generic printing program 41, similar to the procedure for obtaining capability information in C13-C15 of FIG. 3. The support program 42 may also acquire the capability information including the detailed information directly from the printer 2. The support program 42 may also acquire model information only instead of the capability information in G02-G04.

Subsequently, in G05 the support program 42 displays an introductory screen corresponding to the model information contained in the detailed information on the display 13a. For example, the support program 42 determines whether the startup option is added to the startup instruction of the support program 42. This determination condition that the startup option is added to the startup instruction of the support program 42 is an example of the predetermined condition. In other words, the support program 42 determines whether the support program 42 is started by the operating system 21 based on the starting instruction issued immediately after the installation of the support program 42 on the PC 1. The condition that the support program 42 is started by the operating system 21 based on the starting instruction issued immediately after the installation of the support program 42 on the PC 1 is an example of the predetermined condition. When the startup option is added, in G05 the support program 42 displays the introductory screen on the display 13a. This determination in G05 is an example of the step of determining. The process of G05 is an example of the step, process or instruction of displaying. When the support program 42 can provide its own introductory screen that contains introduction information, customer appreciation information, and the like, the support program 42 displays this introductory screen. When not providing its own introductory screen, on the other hand, the support program 42 may display an introductory screen by accessing the web server 4 using its own browser function or the browser of the OS 21 and by displaying a web page provided by the web server 4. After displaying the introductory screen in G05, the support program 42 ends the introduction process and in G06 passes an end notification to the OS 21.

In this way, the support program 42 of the present embodiment displays the introductory screen containing introduction information on the display 13a through a series of steps related to the installation of the support program 42. Accordingly, the user can easily ascertain that the introduction information displayed on the display 13a is related to the printer 2 to be controlled by the support program 42.

The OS 21 subsequently starts up the support program 42 upon receiving an instruction to perform advanced print settings (C11) and upon receiving a print instruction (E02), as shown in FIG. 3. In these cases, the introductory screen is not displayed in the present embodiment because the OS 21 starts up the support program 42 without the startup option described above. Thus, by displaying the introductory screen only when started up after installation, the support program 42 can avoid redundantly displaying introduction information having the same content.

On the other hand, in a case where the support program 42 is started up from the OS 21 when the OS 21 receives an instruction to perform advanced print settings (C11) or when the OS 21 receives a print instruction (E02), as illustrated in FIG. 3, the support program 42 may execute the introduction process shown in FIG. 4 and may redisplay the introductory screen when determining that the predetermined time has elapsed since the introductory screen was previously displayed. In this way, a user who has forgotten many details about the functions and services available to the printer 2 and the support program 42 can be reminded of how to use the printer 2 and other components. The user can also be made aware of information that has been updated since the printer and components were purchased.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. For example, a device connected the PC 1 is not limited to a single-function printer, but may be any printing device having multiple functions, such as a multifunction peripheral, copier machine, and facsimile machine. The number of devices connected to the PC 1 is not limited to that shown in the drawings, but may be two or more.

The introduced printer list 45 may store the printer model in association with the date and time that introduction information was last introduced. In this case, the support program 42 may determine in F01 of FIG. 4 whether the determination condition is satisfied by determining whether the model of the printer 2 connected to the PC 1 is stored in the introduced printer list 45. That is, the determination condition is that the model of the printer 2 connected to the PC 1 is stored in the introduced printer list 45. This determination condition is an example of the predetermined condition.

The introduced printer list 45 may store the number of prints performed since the last time introduction information was displayed in association with the printer model or device identification information. In this case, the support program 42 may determine in F01 of FIG. 4 whether the predetermined condition is satisfied by determining whether the number of prints since the last display of introduction information exceeds a predetermined number. That is, the predetermined condition is that the number of prints since the last display of introduction information exceeds the predetermined number. This determination condition is an example of the predetermined condition.

The introduced printer list 45 may also be omitted. In this case, the support program 42 may store information indicating whether introduction information has been displayed, irrespective of the device identification information or printer model, and may display introduction information on the display 13a when such information is not stored in (or by) the support program 42. However, by storing information indicating whether the introduction information has been displayed for each model of printer, the support program 42 can avoid displaying the same introduction information for multiple printers of the same model after the information was displayed for one of printer of that model. On the other hand, by storing information indicating whether the introduction information has been displayed in association with device identification information for each printer, the support program 42 can display introduction information for each printer, even for printers of the same model.

The support program 42 may also display the introductory screen each time the support program 42 is started. Alternatively, the support program 42 may acquire a device identification number, as the device identification information, from the printer when started up. Here, the device identification number is a number for identifying a printer. When this identification number is not stored in the introduced printer list 45, the support program 42 displays the introduction information and stores the acquired device identification number in the introduced printer list 45. Thus, when each printer is started for the first time, the support program 42 displays the introduction information corresponding to the model of that printer, thereby increasing the likelihood that the user will pay close attention to this introduction information and the like, since users tend to have a strong interest in learning about a printer when the printer is initially started. On the other hand, the introduction information may not be displayed when a startup subsequently to the initial startup because users are less likely to pay attention to this introduction information and may even find the display bothersome when introduction information is displayed the second and subsequent times.

One or both of the customer appreciation display area 102 and support program introduction area 103 shown in FIGS. 5 through 7, for example, may be omitted. However, by displaying a message of thanks on the display 13a thanking the user for purchasing the printer when each printer is started for the first time, the support program 42 can convey the printer manufacturer's thanks (or gratitude) for the purchase of its printer. The support program 42 can also promote its own use by displaying information on how to use the printer and introducing the functions of the support program 42.

The information displayed in the customer appreciation display area 102 of the introductory screens 100, 200, and 300 shown in FIGS. 5 through 7 may be displayed in a screen separate from the introductory screen, for example. Further, the support program information may be included in the introductory screen.

One of either the functions (capabilities, features) or services available to the printer may be excluded from the guidance area 104 in the introductory screens 100, 200, and 300 shown in FIGS. 5 through 7, for example. While a user can be expected to get maximum use from the printer when only one or the other is introduced, this expectation is further enhanced when both functions (capabilities, features) and services are introduced.

The component introduction information on how to use components that are installed in the printer may be excluded from the guidance area 104 in the introductory screens 100, 200, and 300 shown in FIGS. 5 through 7, for example. However, when the support program 42 displays the component introduction information on components mounted in the printer on the display 13a, the user can learn how to use these components. The component introduction information may also be displayed in a separate screen from the introductory screens 100, 200, and 300.

The support program 42 need not acquire the region information but may display on the display 13a introduction information and the like not associated with the region in which the printer is used. However, when the support program 42 displays the introduction information and the like associated with a region on the display 13a, the user can learn modes of use appropriate for that region.

The introduction process shown in FIG. 4 may be executed when the support program 42 is started up from the OS 21 in response to the print instruction (E02) resulting from a print execution instruction inputted by the user in E01, rather than when the support program 42 is started up by the OS 21 in response to an instruction to perform advanced print settings in C12 of FIG. 3. Because the support program 42 displays introduction information in a series of steps related to a printing process, the user can easily perceive that the displayed introduction information relates to the printer. In this case, the introduction information may be displayed either before or after the process for transmitting a print command in E06-E07, but the user may be more likely to benefit from the introduction information when displayed prior to the print command being transmitted.

In the embodiments described above, only printing operations have been described in detail as the operations of the support program 42, but the support program 42 may have other roles. Further, the program that executes the processes described in the embodiments is not limited to the support program 42 but may be another program that receives instructions from the OS 21 or the generic printing program 41 when printing is performed using the generic printing program 41. For example, a print workflow application program having specifications published by Microsoft Corporation may be used as the program.

The execution timing of the support program 42 is not limited to the examples in the embodiments. For example, the support program 42 may be executed in response to execution instructions received directly from the OS 21. Alternatively, the support program 42 may be a resident program, in which case the support program may perform the operations described above upon receiving an execution command.

In any of the sequence charts disclosed in the embodiments, the plurality of processes that make up any of the plurality of steps may be executed in parallel, or the order in which the processes are performed may be modified in any way that does not produce any inconsistencies in the processes.

The processes disclosed in the embodiments may be executed by a single CPU, a plurality of CPUs, an ASIC or other hardware, or a combination of these components. Further, the processes disclosed in the embodiments may be achieved through a storage medium that stores the programs used to implement those processes or according to any of various other methods or formats.

The present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A non-transitory computer readable storage medium storing a support program, the support program supporting a generic printing program implemented with an operating system of an information processing device, the support program, when executed by a processor of the information processing device, causing the information processing device to perform:
in a case where the support program is started by the operating system after a print instruction is issued by an application program, transmitting a print command to a printer via the generic printing program;
in a case where the support program is started by the operating system based on a predetermined instruction, determining whether a predetermined condition is satisfied; and
in a case where the determining determines that the predetermined condition is satisfied, displaying introduction information for a model of the printer on a user interface of the information processing device, the introduction information being information related to how to use the printer.

2. The non-transitory computer readable storage medium according to claim 1, wherein the support program, when executed by the processor, causes the information processing device to further perform:
in a case where the support program is started by the operating system based on the predetermined instruction, acquiring identification information for the printer, the acquiring being performed before the determining; and
in a case where the determining determines that the predetermined condition is satisfied, storing the identification information in a memory of the information processing device,
wherein the predetermined condition includes a requirement that the identification information for the printer is not stored in the memory.

3. The non-transitory computer readable storage medium according to claim 2, wherein the support program, when executed by the processor, causes the information processing device to further perform:
in a case where the determining determines that the predetermined condition is satisfied, displaying a message expressing thanks for purchasing the printer on the user interface.

4. The non-transitory computer readable storage medium according to claim 1, wherein the introduction information includes information related to the model of the printer and information related to a function of the support program.

5. The non-transitory computer readable storage medium according to claim 1, wherein the support program, when executed by the processor, causes the information processing device to further perform:
accessing a web server to acquire a web page for the model of the printer, the web server being configured to supply different web pages for different models of printers, each of the web pages including introduction information for a corresponding one of the models,
wherein the displaying displays the web page including the introduction information for the model of the printer.

6. The non-transitory computer readable storage medium according to claim 1, wherein the support program, when executed by the processor, causes the information processing device to further perform:
acquiring region information indicating a target region for usage of the printer,
wherein the introduction information is based on the region information.

7. The non-transitory computer readable storage medium according to claim 1, wherein the introduction information includes at least one of information related to a capability supported by the model of the printer and information related to a service provided for the model of the printer.

8. The non-transitory computer readable storage medium according to claim 1, wherein the support program, when executed by the processor, causes the information processing device to further perform:
acquiring component information indicating a component mounted in the printer,
wherein the introduction information includes information related to how to use the component indicated in the component information.

9. The non-transitory computer readable storage medium according to claim 1, wherein the predetermined instruction is the print instruction,
wherein the predetermined condition includes a requirement that the support program is started by the operating system based on the print instruction.

10. The non-transitory computer readable storage medium according to claim 1, wherein the predetermined instruction is a starting instruction issued immediately after installation of the support program on the information processing device,
wherein the predetermined condition includes a requirement that the support program is started by the operating system based on the starting instruction issued immediately after the installation of the support program on the information processing device.

11. The non-transitory computer readable storage medium according to claim 1, wherein the print instruction is to instruct the printer to print an image based on image data,
wherein the support program, when executed by the processor, causes the information processing device to further perform:
in a case where the support program is started by the operating system after the print instruction is transmitted from the application program to the generic printing program, receiving the image data from the generic printing program,
wherein the print command transmitted in the transmitting is based on the image data.

12. The non-transitory computer readable storage medium according to claim 1, wherein the introduction information is information prompting an operation to purchase one or more consumables.

13. The non-transitory computer readable storage medium according to claim 1, wherein the introduction information is information related to a service to automatically ship one or more consumables.

14. An information processing device comprising:
a memory;
a user interface; and
a processor,
wherein when a support program is installed on the information processing device for supporting a generic printing program implemented with an operating system of the information processing device and the support program is executed by the processor, the support program causes the information processing device to perform:
in a case where the support program is started by the operating system installed on the information processing device after a print instruction is issued by an application program, transmitting a print command to a printer via the generic printing program;
in a case where the support program is started by the operating system based on a predetermined instruction, determining whether a predetermined condition is satisfied; and
in a case where the determining determines that the predetermined condition is satisfied, displaying introduction information for a model of the printer on the user interface, the introduction information being related to how to use the printer.
